(19) United States
(12) Patent Application Publication
(10) Pub. No.: US 2013/0100820 A1
(43) Pub. Date: Apr. 25, 2013

(54) MAINTAINING A USER EQUIPMENT IN A SHARED CHANNEL STATE IN A WIRELESS COMMUNICATIONS SYSTEM

(71) Applicants: Bongyong SONG, San Diego, CA (US); Yih-Hao LIN, San Diego, CA (US)

(72) Inventors: Bongyong SONG, San Diego, CA (US); Yih-Hao LIN, San Diego, CA (US)

(73) Assignee: QUALCOMM INCORORATED, San Diego, CA (US)

(21) Appl. No.: 13/276,878

(22) Filed: Oct. 19, 2011

(51) Int. Cl. H04W 72/04; H04W 24/00

(52) U.S. Cl. 370/241

(57) ABSTRACT

In an embodiment, a user equipment (UE) is maintained in a shared channel state (e.g., CELL_FACH, etc.) during a period of UE-traffic inactivity that exceeds a threshold inactivity period associated with transitions of the UE from the shared channel state to a dormant state (e.g., CELL_PCH or URA_PCH, etc.). While the UE is being maintained in the shared channel state, the UE receives a request to set-up a communication session. The UE transmits, in response to the received request, a message on a reverse-link shared channel to an access network to facilitate set-up of the requested communication session.

### BACKGROUND OF THE INVENTION

1. Field of the Invention

Embodiments of the invention relate to maintaining a high-priority user equipment (UE) in a shared channel state in a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the Node Bs generally interacts with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, a user equipment (UE) is maintained in a shared channel state (e.g., CELL_FACH, etc.) during a period of UE-traffic inactivity that exceeds a threshold inactivity period associated with transitions of the UE from the shared channel state to a dormant state (e.g., CELL_PCH or URA_PCH, etc.). While the UE is being maintained in the shared channel state, the UE receives a request to set-up a communication session. The UE transmits, in response to the received request, a message on a reverse-link shared channel to an access network to facilitate set-up of the requested communication session.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports user equipments and radio access networks in accordance with at least one embodiment of the invention.

FIG. 2A illustrates the core network of FIG. 1 according to an embodiment of the present invention.

FIG. 2B illustrates an example of the wireless communications system of FIG. 1 in more detail.

FIG. 3 is an illustration of user equipment (UE) in accordance with at least one embodiment of the invention.

FIG. 4A illustrates a process of sending a call request message from an originating UE that begins in a paging channel (PCH) state.

FIG. 4B illustrates another process of sending a call request message from an originating UE that begins in a PCH state.

FIGS. 4C and 4D each illustrate examples of a target UE that transitions from a PCH state to CELL_FACH or CELL_DCH state in order to receive downlink or mobile-terminated traffic.

FIG. 5 illustrates a process of establishing a communication session between an originating UE and a target UE in accordance with an embodiment of the invention.

FIG. 6 illustrates another process of establishing a communication session between the originating UE and the target UE in accordance with another embodiment of the invention.

FIGS. 7A through 7C each illustrate different example implementations of a portion of FIGS. 5 and/or 6.

FIG. 8 illustrates a communication device 800 that includes logic configured to perform functionality.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple UEs.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

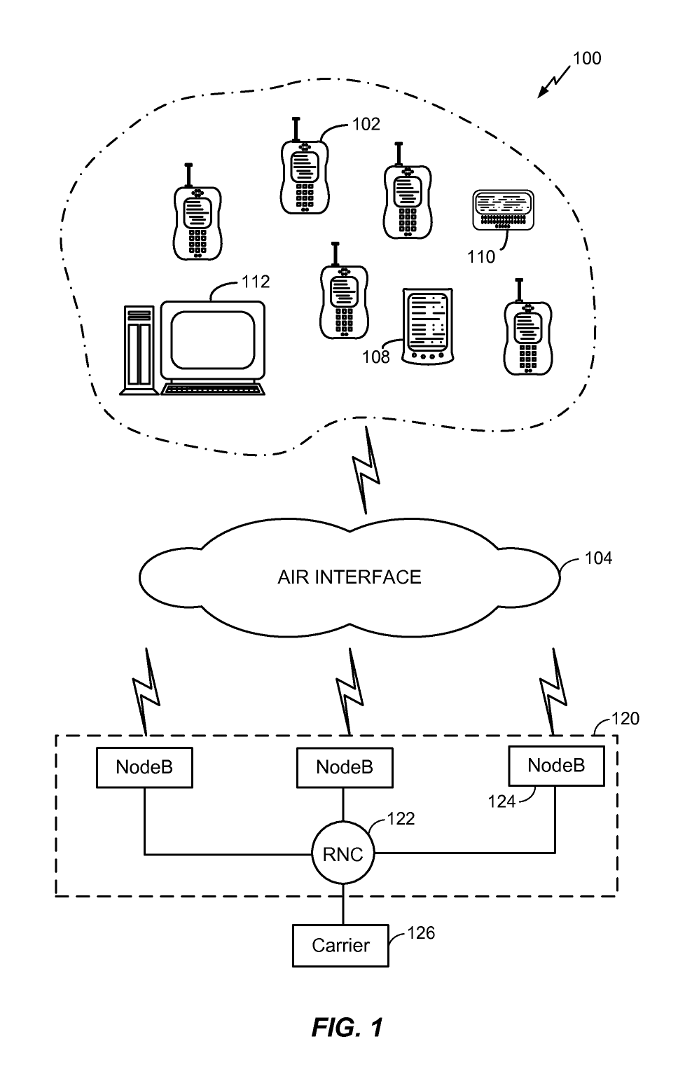

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

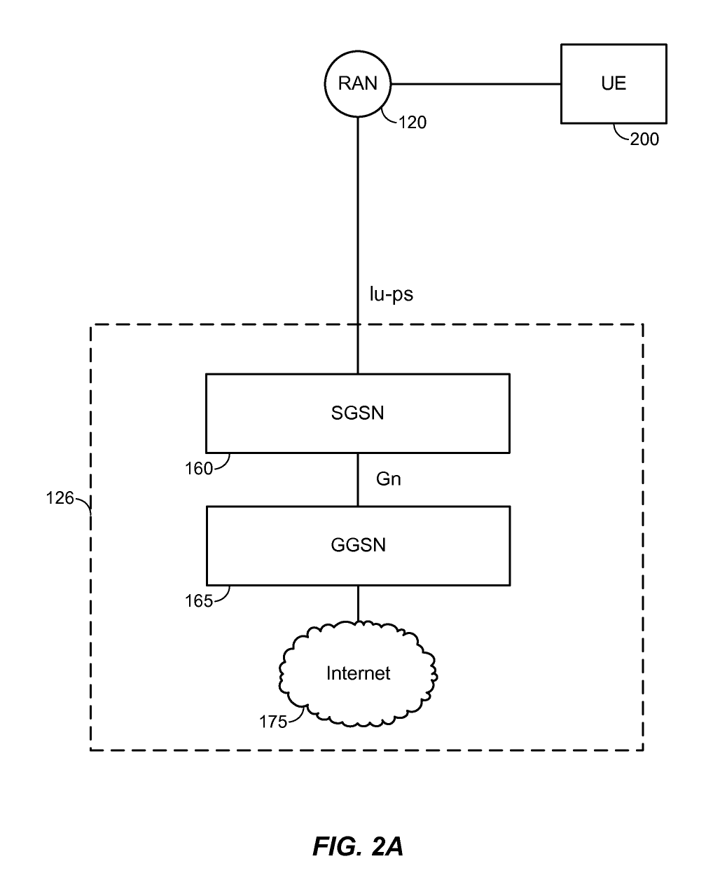

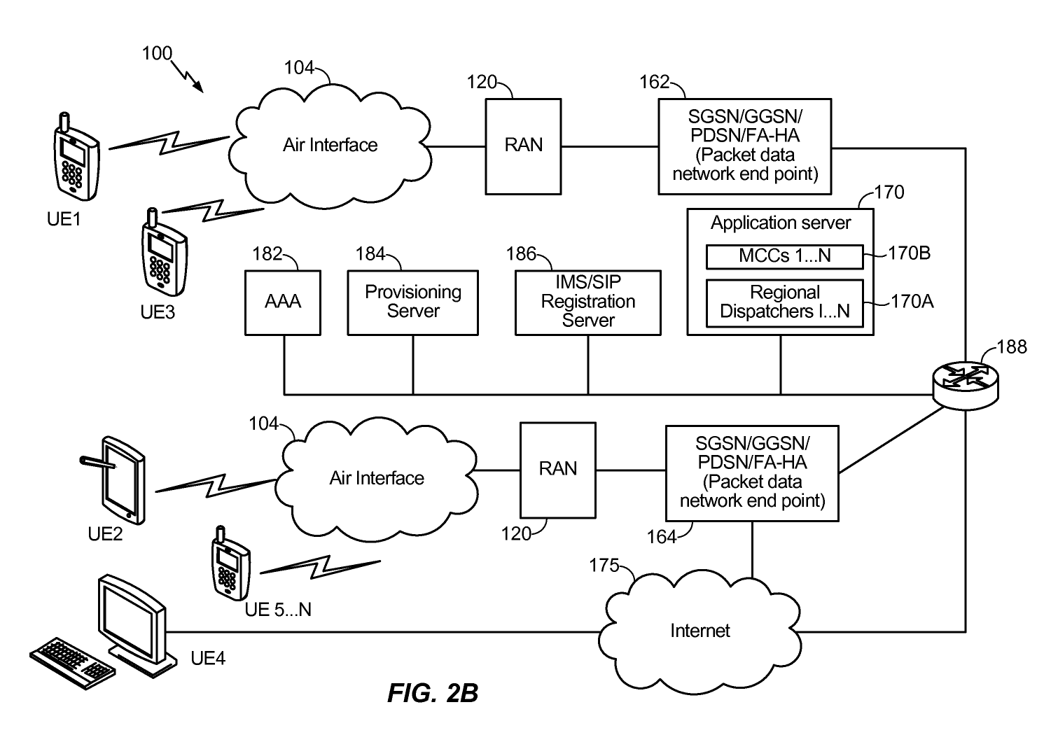

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SSGN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reachability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Iu interface, with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP′, etc.). While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2B illustrates an example of the wireless communications system 100 of FIG. 1 in more detail. In particular, referring to FIG. 2B, UEs 1 . . . N are shown as connecting to the RAN 120 at locations serviced by different packet data network end-points. The illustration of FIG. 2B is specific to W-CDMA systems and terminology, although it will be appreciated how FIG. 2B could be modified to confirm with a 1×EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2B, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2B are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2B, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

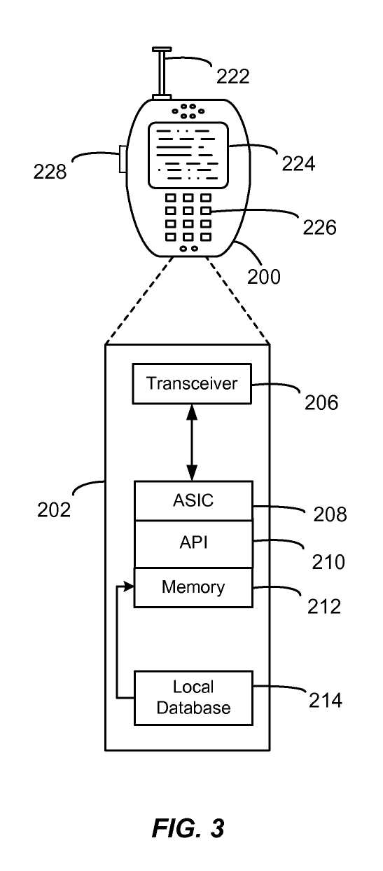

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

Below, embodiments of the invention are generally described in accordance with W-CDMA protocols and associated terminology (e.g., such as UE instead of mobile station (MS), mobile unit (MU), access terminal (AT), etc., RNC, contrasted with BSC in EV-DO, or Node B, contrasted with BS or MPT/BS in EV-DO, etc.). However, it will be readily appreciated by one of ordinary skill in the art how the embodiments of the invention can be applied in conjunction with wireless communication protocols other than W-CDMA.

In a conventional server-arbitrated communication session (e.g., via half-duplex protocols, full-duplex protocols, VoIP, a group session over IP unicast, a group session over IP multicast, a push-to-talk (PTT) session, a push-to-transfer (PTX) session, etc.), a session or call originator sends a request to initiate a communication session to the application server 170, which then forwards a call announcement message to the RAN 120 for transmission to one or more targets of the call.

User Equipments (UEs), in a Universal Mobile Telecommunications Service (UMTS) Terrestrial Radio Access Network (UTRAN) (e.g., the RAN 120) may be in either an idle mode or a radio resource control (RRC) connected mode.

Based on UE mobility and activity while in a RRC connected mode, the RAN 120 may direct UEs to transition between a number of RRC sub-states; namely, CELL_PCH, URA_PCH, CELL_FACH, and CELL_DCH states, which may be characterized as follows:
In the CELL_DCH state, a dedicated physical channel is allocated to the UE in uplink and downlink, the UE is known on a cell level according to its current active set, and the UE has been assigned dedicated transport channels, downlink and uplink (TDD) shared transport channels, and a combination of these transport channels can be used by the UE.
In the CELL_FACH state, no dedicated physical channel is allocated to the UE, the UE monitors (e.g., the monitoring can be continuous in an example, although the UE can refrain from monitoring the downlink including the FACH during DRX in Rel. 8+) a forward access channel (FACH), the UE is assigned a default common or shared transport channel in the uplink (e.g., a random access channel (RACH), which is a contention-based channel with a power ramp-up procedure to acquire the channel and to adjust transmit power) that the UE can transmit upon according to the access procedure for that transport channel, the position of the UE is known by RAN 120 on a cell level according to the cell where the UE last made a previous cell update, and, in TDD mode, one or several USCH or DSCH transport channels may have been established.
In the CELL_PCH state, no dedicated physical channel is allocated to the UE, the UE selects a PCH with the algorithm, and uses DRX for monitoring the selected PCH via an associated PICH, no uplink activity is possible and the position of the UE is known by the RAN 120 on cell level according to the cell where the UE last made a cell update in CELL_FACH state.
In the URA_PCH state, no dedicated channel is allocated to the UE, the UE selects a PCH with the algorithm, and uses DRX for monitoring the selected PCH via an associated PICH, no uplink activity is possible, and the location of the UE is known to the RAN 120 at a Registration area level according to the UTRAN registration area (URA) assigned to the UE during the last URA update in CELL_FACH state.

Accordingly, URA_PCH State (or CELL_PCH State) corresponds to a dormant state where the UE periodically wakes up to check a paging indicator channel (PICH) and, if needed, the associated downlink paging channel (PCH), and it may enter CELL_FACH state to send a Cell Update message for the following event: cell reselection, periodical cell update, uplink data transmission, paging response, re-entered service area. In CELL_FACH State, the UE may send messages on the random access channel (RACH), and may monitor a forward access channel (FACH). The FACH carries downlink communication from the RAN 120, and is mapped to a secondary common control physical channel (S-CCPCH). From CELL_FACH State, the UE may enter CELL_DCH state after a traffic channel (TCH) has been obtained based on messaging in CELL_FACH state. A table showing conventional dedicated traffic channel (DTCH) to transport channel mappings in radio resource control (RRC) connected mode, is in Table 1 as follows:

TABLE 1
DTCH to Transport Channel mappings in RRC connected mode

| | RACH | FACH | DCH | E-DCH | HS-DSCH |
|---|---|---|---|---|---|
| CELL_DCH | No | No | Yes | Yes | Yes |
| CELL_FACH | Yes | Yes | No | Yes (rel.8) | Yes (rel.7) |
| CELL_PCH | No | No | No | No | Yes (rel.7) |
| URA_PCH | No | No | No | No | No |

wherein the notations (rel. 8) and (rel. 7) indicate the associated 3GPP release where the indicated channel was introduced for monitoring or access.

Communication sessions arbitrated by the application server 170, in at least one embodiment, may be associated with delay-sensitive or high-priority applications and/or services. For example, the application server 170 may correspond to a PTT server in at least one embodiment, and it will be appreciated that an important criterion in PTT sessions is fast session set-up as well as maintaining a given level of Quality of Service (QoS) throughout the session.

As discussed above, in RRC connected mode, a given UE can operate in either CELL_DCH or CELL_FACH to exchange data with the RAN 120, through which the given UE can reach the application server 170. As noted above, in CELL_DCH state, uplink/downlink Radio bearers will consume dedicated physical channel resources (e.g., UL DCH, DL DCH, E-DCH, F-DPCH, HS-DPCCH etc). Some of these resources are even consumed for high speed shared channel (i.e., HSDPA) operations. In CELL_FACH state, uplink/downlink Radio bearers will be mapped to common transport channels (RACH/FACH). Thereby, in CELL_FACH state there is no consumption of dedicated physical channel resources.

Conventionally, the RAN 120 transitions the given UE between CELL_FACH and CELL_DCH based substantially on traffic volume, which is either measured at the RAN 120 (e.g., at the serving RNC 122 at the RAN 120) or reported from the given UE itself in one or more measurement reports. Specifically, the RAN 120 can conventionally be configured to transition a particular UE to CELL_DCH state from CELL_FACH state when the UE's associated traffic volume as measured and/or reported in the uplink or as measured and/or reported in the downlink is higher than the one or more of the Event 4a thresholds used by the RAN 120 for making CELL_DCH state transition decisions.

Conventionally, when an originating UE attempts to send a call request message to the application server 170 to initiate a communication session (or an alert message to be forwarded to one or more target UEs), the originating UE performs a cell update procedure, after which the originating UE transitions to either CELL_FACH state or CELL_DCH state. If the originating UE transitions to CELL_FACH state, the originating UE can transmit the call request message on the RACH to the RAN 120. Otherwise, if the originating UE transitions to CELL_DCH state, the originating UE can transmit the call request message on the reverse-link DCH or E-DCH to the RAN 120. Call request messages are generally relatively small in size, and are not typically expected to exceed the Event 4a threshold(s) used by the RAN 120 in determining whether to transition the originating UE to CELL_DCH state.

In CELL_FACH state, the originating UE can begin transmission of the call request message more quickly (e.g., because no radio link (RL) need be established between a serving Node B and serving RNC at the RAN 120, no L1 synchronization procedure need be performed between the originating UE and the serving Node B, etc.) and no DCH-resources are consumed by the originating UE. However, the RACH is generally associated with lower data rates as compared to the DCH or E-DCH. Thus, while potentially permitting the transmission of the call request message to start earlier at an earlier point in time, the transmission of the call request message on the RACH may take a longer time to complete as compared to a similar transmission on the DCH or E-DCH in some instances. Accordingly, it is generally more efficient for the originating UE to send higher traffic volumes on the DCH or E-DCH as compared to the RACH, while smaller messages can be sent with relative efficiency on the RACH without incurring overhead from DCH set-up.

As noted above, the originating UE's state (e.g., CELL_DCH or CELL_FACH) is determined based on the amount of uplink data to be sent by the originating UE. For example, the standard defines an Event 4a threshold for triggering a Traffic Volume Measurement (TVM) report. The Event 4a threshold is specified in the standard, and is used by the UE for triggering Traffic Volume Measurement Report, which summarizes the buffer occupancy of each uplink Radio Bearer.

Other parameters which are not defined in the standard are an uplink Event 4a threshold for triggering the state transition of a given UE to CELL_DCH state, and a downlink Event 4a threshold for triggering the state transition of the given UE to CELL_DCH state. As will be appreciated, the uplink and downlink Event 4a thresholds being ‘undefined’ in the standard means that the respective thresholds can vary from vendor to vendor, or from implementation to implementation at different RANs.

Referring to the uplink Event 4a threshold, in CELL_FACH state, if the reported uplink buffer occupancy of each Radio Bearer exceeds the uplink Event 4a threshold, the RNC 122 moves the UE to CELL_DCH. In an example, this decision may be made based on the aggregated buffer occupancy or individual Radio Bearer buffer occupancy. If aggregated buffer occupancy is used for deciding the CELL_DCH transition, the same threshold for triggering TVM can be used. Similarly, referring to the downlink Event 4a threshold, in CELL_FACH state, if the downlink buffer occupancy of the Radio Bearers of the UE exceeds the downlink Event 4a threshold, the RNC 122 moves the UE to CELL_DCH state. In an example, this decision may be done based on the aggregated buffer occupancy or individual Radio Bearer buffer occupancy.

Accordingly, the size of the call request message can determine whether the originating UE is transitioned to CELL_FACH state or CELL_DCH state. Specifically, one of the Event 4a thresholds is conventionally used to make the CELL_DCH state determination at the RAN 120. Thus, when the Event 4a threshold is exceeded, the RAN 120 triggers the CELL_DCH state transition of the UE.

However, the processing speed or responsiveness of the RAN 120 itself can also affect whether the CELL_DCH state or CELL_FACH state is a more efficient option for transmitting the call request message. For example, if the RAN 120 is capable of allocating DCH resources to an originating UE within 10 milliseconds (ms) after receiving a cell update message, the CELL_DCH state transition of the originating UE may be relatively fast so that transitions to DCH may be suitable for transmitting delay-sensitive call request messages. On the other hand, if the RAN 120 is capable of allocating DCH resources to an originating UE only after 100 milliseconds (ms) after receiving a cell update message, the CELL_DCH state transition of the originating UE may be relatively slow, so that the transmission of the call request message may actually be completed faster on the RACH.

As will be appreciated, the Event 4a threshold(s) are typically set high enough to achieve efficient resource utilization, as lower Event 4a thresholds will cause more frequent DCH resource allocations to UEs that do not necessarily require DCHs to complete their data exchange in a timely manner. However, it is possible that data transmissions that do not exceed the Event 4a threshold can be transmitted more quickly either in CELL_FACH state or CELL_DCH state based on the processing speed of the RAN 120 and the amount of data to be transmitted. However, as noted above, conventional RANs do not evaluate criteria aside from whether measured or reported traffic volume exceeds the Event 4a threshold(s) in making the CELL_DCH state transition determination.

In W-CDMA Rel. 6, a new feature referred to as a Traffic Volume Indicator (TVI) is introduced, whereby the originating UE has the option of including the TVI within the cell update message during a cell update procedure. The RAN 120 will interpret a cell update message including the TVI (i.e., TVI=True) as if the Event 4a threshold for triggering a TVM report was exceeded (i.e., in other words, as if the uplink traffic volume buffer occupancy exceeds the Event 4a threshold for triggering a TVM report), such that the RAN 120 will transition the originating UE directly to the CELL_DCH state. Alternatively, if the TVI is not included in the cell update message, the RAN 120 will only transition the originating UE to CELL_DCH state upon receipt of a Traffic Volume Measurement Report for Event 4a.

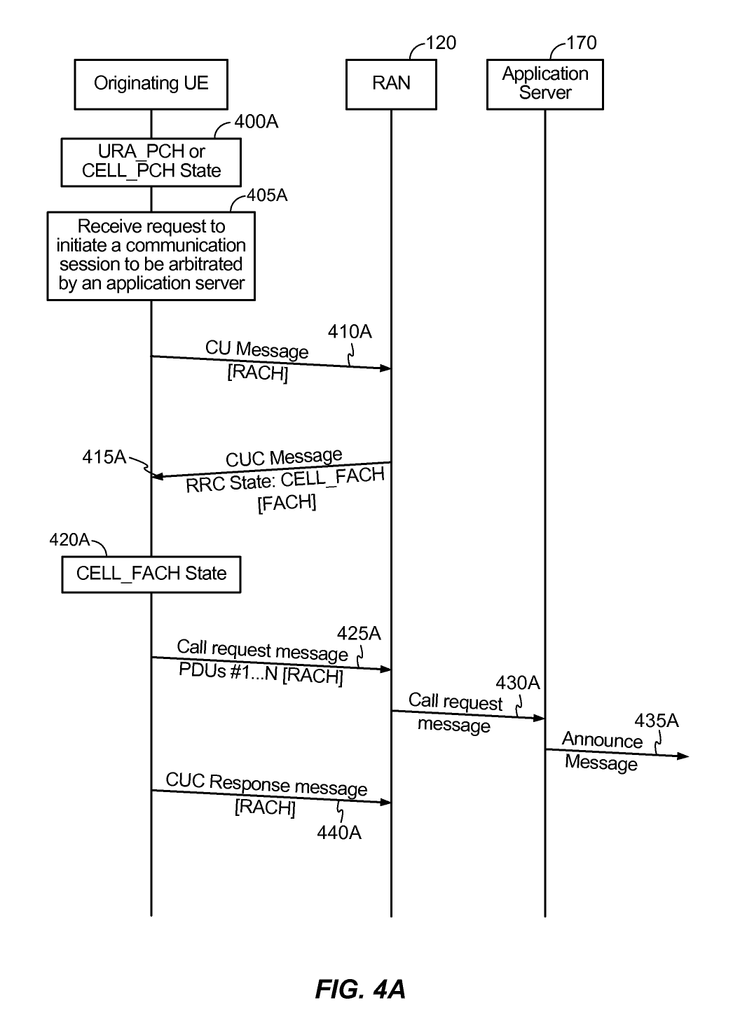

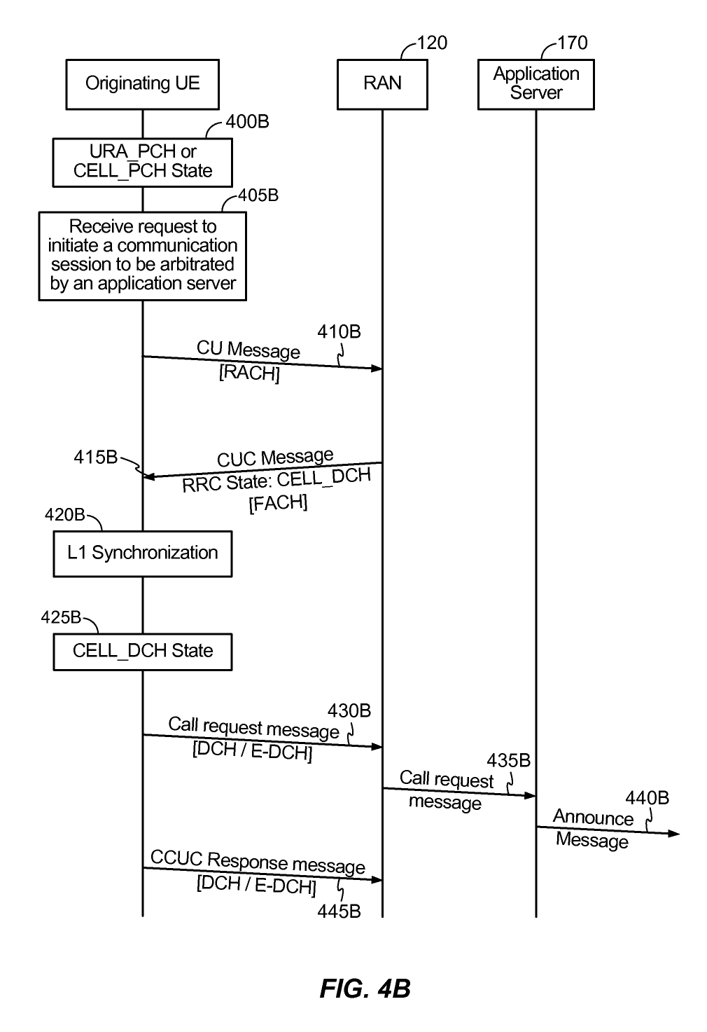

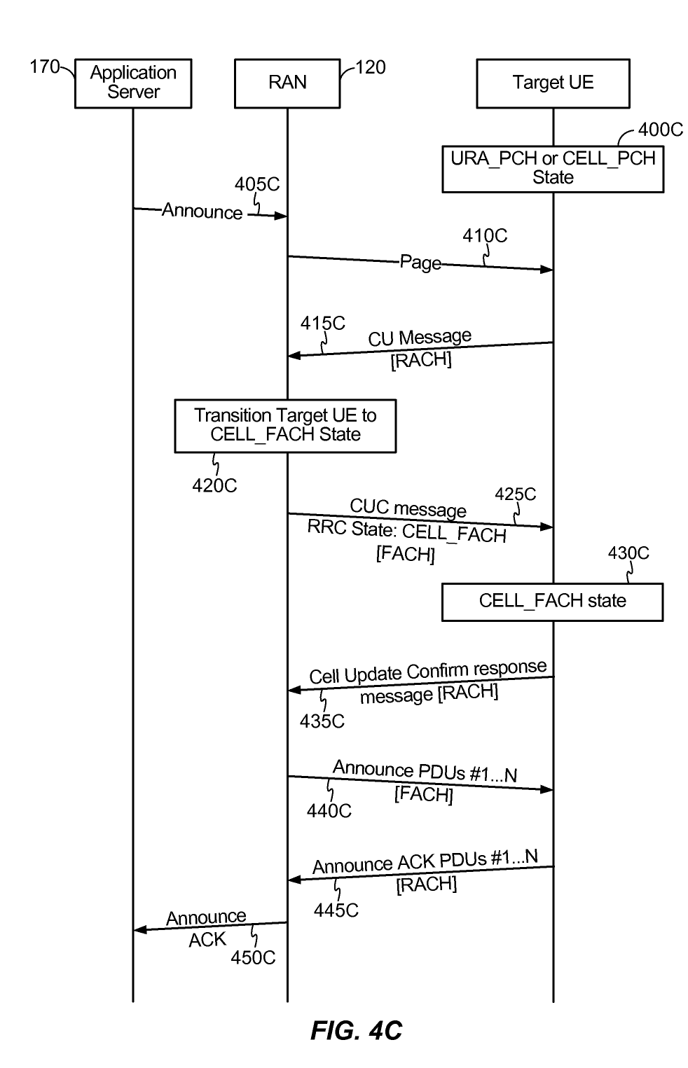

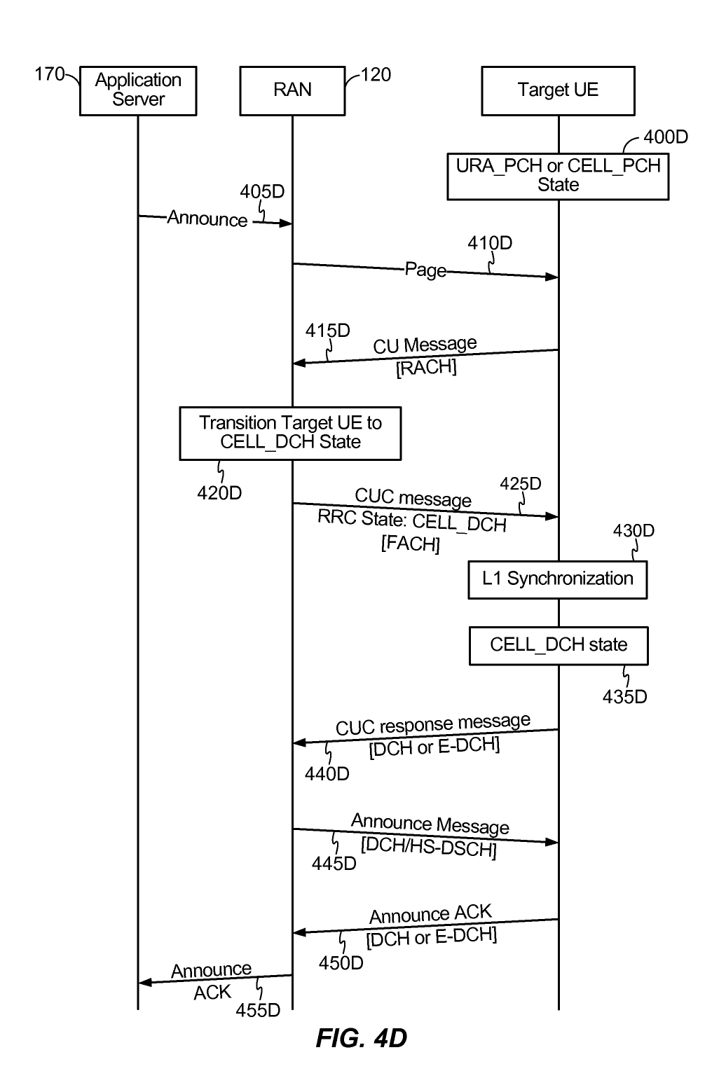

The discussion presented above related to transitions between CELL_DCH and CELL_FACH state is relevant to scenarios where an originating UE has reverse-link data to transmit to the RAN 120 and/or when the RAN 120 has downlink data to send to the UE. When the UE is in CELL_FACH state and no data is exchanged between the UE and the RAN 120 for a threshold period of time, the UE is transitioned back to CELL_PCH or URA_PCH state to conserve power. This threshold period of time is referred to as a FACH to PCH (F2P) inactivity time period. Generally, the UE consumes less power in CELL_PCH or URA_PCH state as compared to CELL_FACH state, such that relatively long periods of inactivity will cause the UE to be transitioned to the lower-power state (CELL_PCH or URA_PCH). However, as shown in FIGS. 4A through 4D, beginning a data transfer with a UE in URA_PCH or CELL_PCH state necessitates a cell update procedure to be performed before the UE can be transitioned into CELL_FACH or CELL_DCH state for transmitting or receiving the data.

FIG. 4A illustrates a process of sending a call request message from an originating UE that begins in a PCH state (e.g., URA_PCH or CELL_PCH). Referring to FIG. 4A, assume that the originating UE has been dormant (i.e., inactive in terms of traffic transmitted to the RAN 120 and/or received from the RAN 120) for a period of time and is in either URA_PCH or CELL_PCH state, 400A. Next, the originating UE receives a request to initiate a communication session to be arbitrated by the application server 170, 405A. For example, the request of 405A can be received from a user of the originating UE and the requested communication session can correspond to a call between the originating UE and one or more target UEs.

Referring to FIG. 4A, in response to the request from 405A, the originating UE transmits a cell update message on the RACH to the RAN 120, 410A, and the RAN 120 responds to the cell update message with a cell update confirm message on the FACH, 415A. In the example of FIG. 4A, assume that the cell update confirm message of 415A is configured to transition the originating UE into CELL_FACH state instead of CELL_DCH state. While not shown explicitly in FIG. 4A, the originating UE's transition to CELL_FACH state instead of CELL_DCH state can be based on a TVI field in the cell update message of 410A being set to FALSE or “0”, a TVM report value, logic implemented at the RAN 120, and so on.

The originating UE receives the cell update confirm message, transitions into CELL_FACH state, 420A, and then transmits a series of packet data units (PDUs) 1 . . . N corresponding to the call request message to the RAN 120 over the RACH, 425A. After each PDU of the call request message is received, the RAN 120 forwards the call request message from the originating UE to the application server 170, 430A, and the application server 170 identifies one or more target UEs associated with the requested call and then transmits an announce message to the one or more identified target UEs, 435A. Also, after transitioning to CELL_FACH state in 420A, the originating UE transmits a cell update confirm response message over the RACH to the RAN 120, 440A. It will be appreciated that the cell update confirm response message of 440A can either be transmitted after the call request PDUs 1 . . . N of 425A, or alternatively can be transmitted before the call request PDUs 1 . . . N of 425A.

FIG. 4B illustrates another process of sending a call request message from an originating UE that begins in a PCH state (e.g., URA_PCH or CELL_PCH). FIG. 4B is similar to FIG. 4A except that the originating UE is transitioned into CELL_DCH state for transmitting the call request message instead of CELL_FACH state.

Thus, 400B and 405B of FIG. 4B correspond to 400A and 405A, respectively, of FIG. 4A. Next, in response to the request from 405B, the originating UE transmits a cell update message on the RACH to the RAN 120, 410B, and the RAN 120 responds to the cell update message with a cell update confirm message on the FACH, 415B. In the example of FIG. 4B, assume that the cell update confirm message of 415B is configured to transition the originating UE into CELL_DCH state instead of CELL_FACH state. While not shown explicitly in FIG. 4B, the originating UE's transition to CELL_DCH state instead of CELL_FACH state can be based on a TVI field in the cell update message of 410B being set to TRUE or “1”, a TVM report value, logic implemented at the RAN 120, and so on.

The originating UE receives the cell update confirm message and performs an L1 synchronization procedure with the RAN 120, 420B, in order to transition into CELL_DCH state, 425B. Once the originating UE enters CELL_DCH state, the originating UE transmits the call request message to the RAN 120 over the DCH or E-DCH, 430B. As will be appreciated, the transmission of the call request message at 430B over the DCH or E-DCH in CELL_DCH state is transmitted more quickly than the multiple PDUs 1 . . . N of the call request message that are transmitted at 425A of FIG. 4A over the RACH in CELL_FACH state, although the call request PDUs 1 . . . N shown in FIG. 4A can begin to be transmitted at an earlier point in time due to the quicker state transition.

Referring to FIG. 4B, the RAN 120 forwards the call request message from the originating UE to the application server 170, 435B, and the application server 170 identifies one or more target UEs associated with the requested call and then transmits an announce message to the one or more identified target UEs, 440B. Also, after transitioning to CELL_DCH state in 425B, the originating UE transmits a cell update confirm response message over the RACH to the RAN 120, 445B. It will be appreciated that the cell update confirm response message of 445B can either be transmitted after the call request message of 430B, or alternatively can be transmitted before the call request message of 430B.

While FIGS. 4A and 4B are directed to a transition of a dormant UE (i.e., a UE in a PCH state) to CELL_FACH or CELL_DCH state in order to transmit a call request message (i.e., uplink or mobile-originated traffic) for initiating a server-arbitrated communication session, FIGS. 4C and 4D are each directed to an example of a target UE that transitions from a PCH state to CELL_FACH or CELL_DCH state in order to receive downlink or mobile-terminated traffic.

Referring to FIG. 4C, assume that a target UE has been dormant (i.e., inactive in terms of traffic transmitted to the RAN 120 and/or received from the RAN 120) for a period of time and is in either URA_PCH or CELL_PCH state, 400C. Next, the RAN 120 receives, from the application server 170, a request to transmit an announce message configured to announce a communication session to the target UE, 405C. Because the target UE is in URA_PCH or CELL_PCH state, the RAN 120 is not necessarily aware of the target UE's location at a sector-level granularity and thereby transmits a paging message to the target UE within a paging area that includes a number of sectors, 410C. The target UE receives the paging message and responds to the paging message with a cell update message on the RACH, 415C. The RAN 120 receives the cell update message and determines to transition the target UE into CELL_FACH state, 420C. For example, while not shown explicitly in FIG. 4C, the RAN 120's decision to transition the target UE into CELL_FACH state instead of CELL_DCH state can be based on a size of the announce message from 405C being below a threshold, a TVI field in the cell update message of 415C being set to FALSE or “0”, logic implemented at the RAN 120, and so on.

Referring to FIG. 4C, the RAN 120 responds to the cell update message with a cell update confirm message on the FACH, 425C. In the example of FIG. 4C, assume that the cell update confirm message of 425C is configured to transition the target UE into CELL_FACH state instead of CELL_DCH state. The target UE receives the cell update confirm message and transitions into CELL_FACH state, 430C, and transmits a cell update confirm response message on the RACH to the RAN 120, 435C. The RAN 120 receives the cell update confirm message and then transmits a series of packet data units (PDUs) 1 . . . N corresponding to the announce message to the target UE over the FACH, 440C. The target UE responds to the announce message with a series of PDUs 1 . . . N (e.g., the announce acknowledgment can be relatively small, so N may equal 1) corresponding to an acknowledgment that indicates the target UE's acceptance of the announced communication session over the RACH, 445C, and the RAN 120 forwards the announce acknowledgment to the application server 170, 450C, which can then connect the call between the originating UE and the target UE.

FIG. 4D is similar to FIG. 4C except that the target UE is transitioned into CELL_DCH state for transmitting the call request message instead of CELL_FACH state.

Referring to FIG. 4D, 400D through 415D of FIG. 4D correspond to 400C through 415C, respectively, of FIG. 4C. Next, the RAN 120 receives the cell update message in 415D and determines to transition the target UE into CELL_DCH state, 420D. For example, while not shown explicitly in FIG. 4D, the RAN 120's decision to transition the target UE into CELL_DCH state instead of CELL_FACH state can be based on a size of the announce message from 405D being greater than or equal to a threshold, a TVI field in the cell update message of 415D being set to TRUE or “1”, logic implemented at the RAN 120, and so on.

Referring to FIG. 4D, the RAN 120 responds to the cell update message with a cell update confirm message on the FACH, 425D. In the example of FIG. 4D, assume that the cell update confirm message of 425D is configured to transition the target UE into CELL_FACH state instead of CELL_DCH state. The target UE receives the cell update confirm message and performs an L1 synchronization procedure with the RAN 120, 430D, in order to transition into CELL_DCH state, 435D. The target UE then transmits a cell update confirm response message on the DCH or E-DCH to the RAN 120, 440D. The RAN 120 receives the cell update confirm message and then transmits the announce message to the target UE over the DCH or HS-DSCH, 445D. As will be appreciated, the transmission of the announce message at 445D over the DCH or HS-DSCH in CELL_DCH state is transmitted more quickly than the multiple PDUs 1 . . . N of the announce message that are transmitted at 440C of FIG. 4C over the FACH in CELL_FACH state, although the announce PDUs 1 . . . N shown in FIG. 4C can begin to be transmitted at an earlier point in time due to the quicker state transition. The target UE responds to the announce message with an acknowledgment that indicates target UE's acceptance of the announced communication session over the DCH or E-DCH, 450D, and the RAN 120 forwards the announce acknowledgment to the application server 170, 455D, which can then connect the call between the originating UE and the target UE.

With respect to FIGS. 4A through 4D, it will be appreciated that the cell update procedure required to transition UEs from a PCH state into CELL_FACH state or CELL_DCH state adds delay or lag to the transfer of the call request message or announce message between the RAN 120 and the originating or target UEs. In most instances, this delay is considered to be justified by the power savings at the UE by virtue of residing in a PCH state during dormant periods (i.e., periods of traffic inactivity) instead of CELL_FACH state. However, it will be appreciated that each millisecond of delay can be important with respect to delay-sensitive or latency-sensitive services, such as public safety PTT systems or other emergency responder services. For these cases, maintaining the UE in a high-power state may be worth implementing to achieve quicker exchanges of data even at the cost of battery life, which may necessitate larger batteries or frequent charging of the UEs.

Accordingly, embodiments of the invention are directed to maintaining one or more high-priority UEs that subscribe to a delay-sensitive multimedia service (e.g., PTT, etc.) in an intermediate-power state (e.g., CELL_FACH state) that is associated with quicker exchanges of data as compared to a UE that returns to a dormant state (e.g., CELL_PCH or URA_PCH state) during periods of dormancy or traffic inactivity.

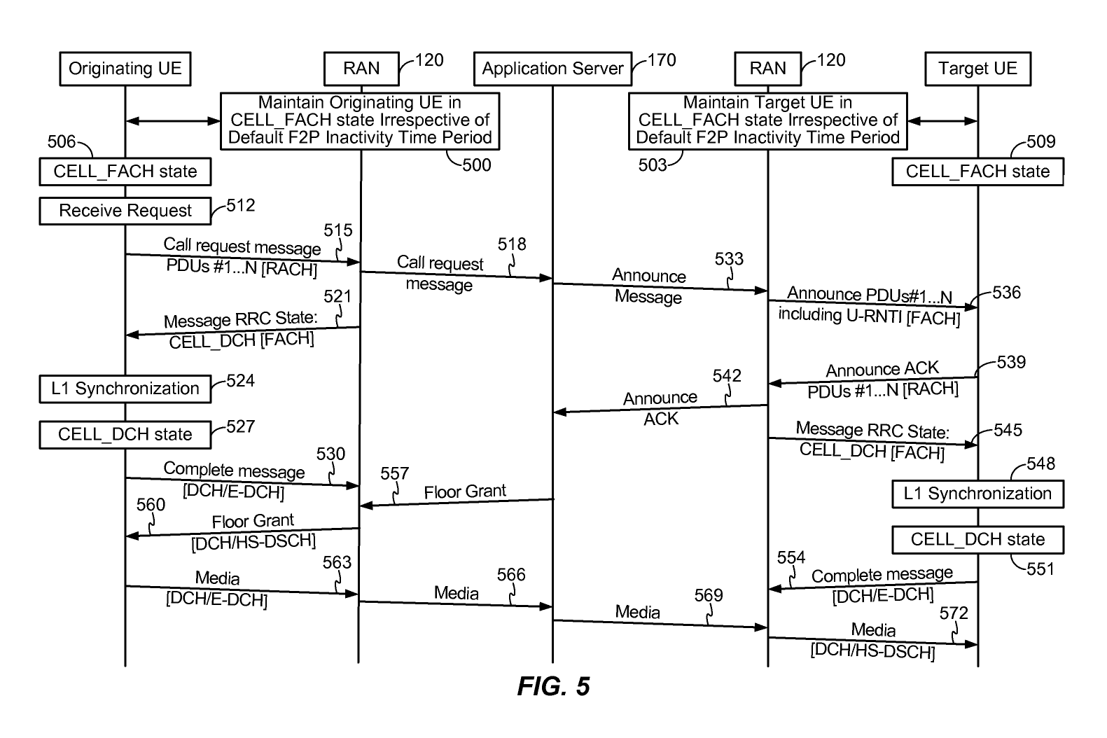

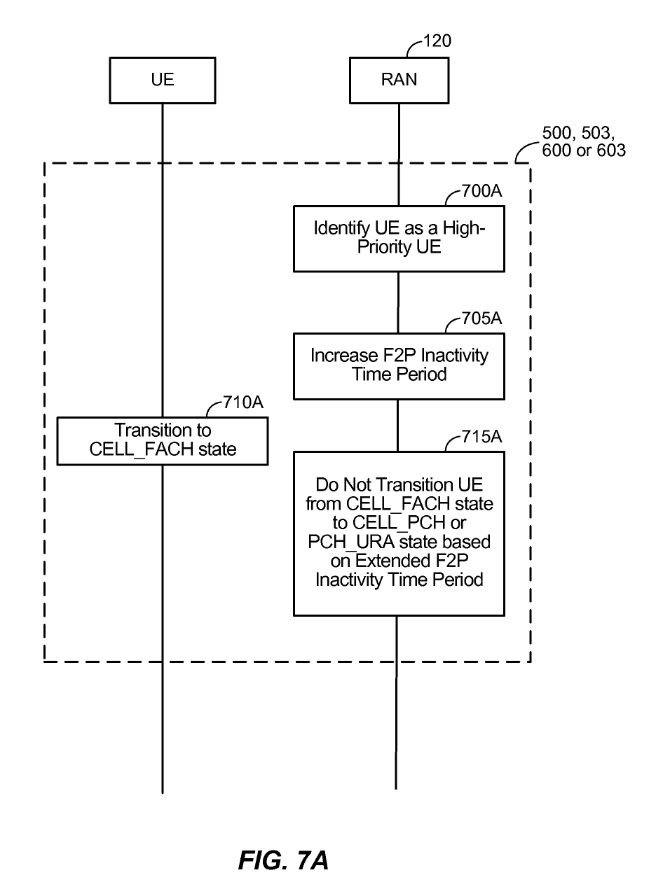

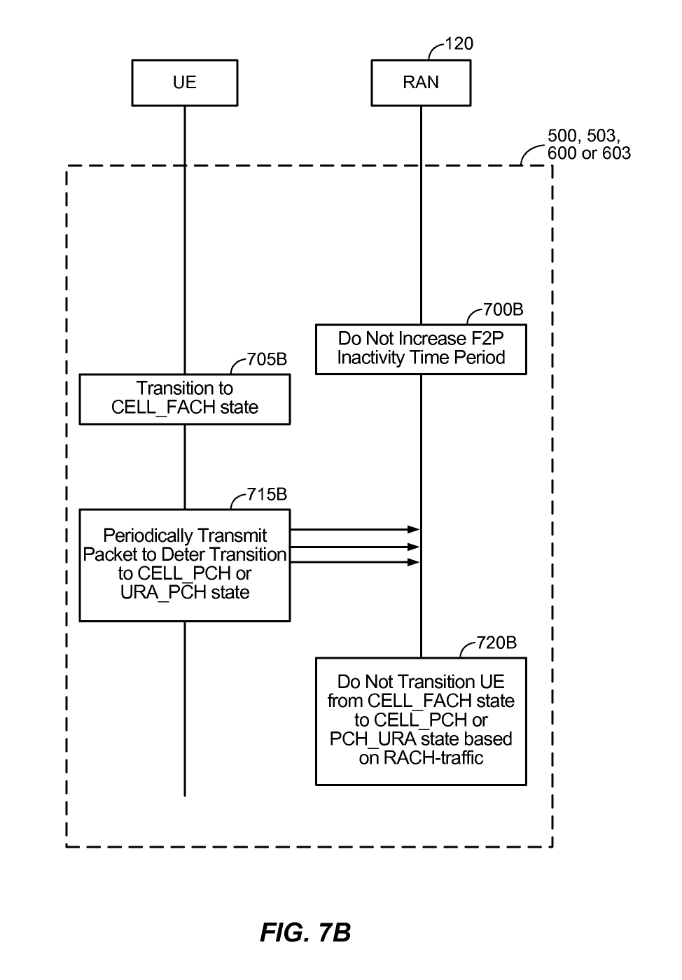

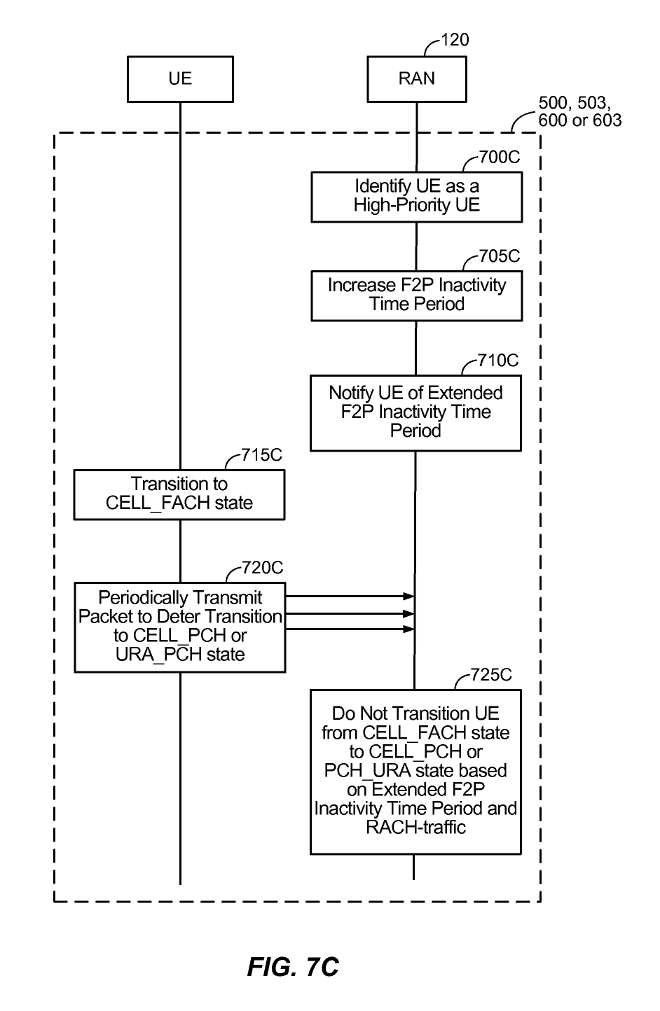

FIG. 5 illustrates a process of establishing a communication session between an originating UE and a target UE in accordance with an embodiment of the invention. Referring to FIG. 5, the RAN 120 and/or the originating UE execute a protocol to maintain the originating UE in CELL_FACH state, 500. More specifically, in 500, the originating UE is permitted to remain in CELL_FACH state for a period of time that is extended from the F2P inactivity time period discussed above, either based upon operation of the originating UE, the RAN 120 or both. Because the originating UE is maintained in CELL_FACH state in 500, it will be appreciated that the originating UE remains provisioned with a cell radio network temporary identifier (C-RNTI) and a dedicated HS-DSCH Radio Network Transaction Identifier (H-RNTI). Also, always-on signaling radio bearers (SRBs), an Iu-PS signaling connection and one or more other radio bearers (RABs) are also maintained for the originating UE in 500. As discussed above, being in CELL_FACH state means that the originating UE does not have dedicated channel resources, the originating UE monitors the FACH, the UE is permitted to transmit on the RACH and the RAN 120 tracks the location of the originating UE at a sector-level granularity. Similarly, the RAN 120 and/or the target UE execute a protocol to maintain the target UE in CELL_FACH state, 503. Generally, the operation of 503 may be the same as 500 except 500 applies to the originating UE and 503 applies to the target UE. Also, example implementations of 500 of FIG. 5 are provided in more detail below with respect to FIGS. 7A through 7C.

Accordingly, at some later point in time, the originating UE and the target UE each remain in CELL_FACH state, 506 and 509. Next, the originating UE receives a request to initiate a communication session to be arbitrated by the application server 170, 512. For example, the request of 512 can be received from a user of the originating UE and the requested communication session can correspond to a call between the originating UE and one or more target UEs.

Referring to FIG. 5, in response to the request from 512, because the originating UE is already in CELL_FACH state, the originating UE transmits a series of packet data units (PDUs) 1 . . . N corresponding to a call request message to the RAN 120 over the RACH, 515. The RAN 120 forwards the call request message from the originating UE to the application server 170, 518. Also, after the call request message completes its transmission to the RAN 120 in 515, the RAN 120 transmits a reconfiguration message on the FACH to the originating UE to facilitate a transition of the originating UE to CELL_DCH state, 521. As will be appreciated, the reconfiguration message of 521 corresponds to a Radio Bearer (RB) Reconfiguration message, a Transport Channel (TCH) Reconfiguration message or a Physical Channel (PCH) Reconfiguration message, based on whether the Radio Bearer, Transport Channel or Physical Channel is the higher layer of the originating UE to be reconfigured.

The originating UE receives the reconfiguration message, performs an L1 synchronization procedure, 524, completes transition to CELL_DCH state, 527, and then transmits a reconfiguration complete message on the DCH or E-DCH to the RAN 120, 530. While not shown explicitly in FIG. 5, the RAN 120 may be prompted to transition the originating UE to CELL_DCH state at 521 based on downlink traffic (e.g., a dummy packet exceeding an Event 4a threshold) from the application server 170, in an example.

Turning back to the application server 170, after receiving the forwarded call request message from the RAN 120 in 518, the application server identifies the target UE as a target of the communication session and then requests that the RAN 120 transmit an announce message to the target UE, 533. Because the RAN 120 is aware of the target UE's current sector and knows that the target UE is operating in CELL_FACH state, the RAN 120 transmits a series of PDUs 1 . . . N corresponding to the announce message to the target UE over the FACH, 536. In other words, no cell update procedure or paging needs to occur before the RAN 120 can begin transmission of the announce message to the target UE, as in FIGS. 4C and 4D.

The target UE responds to the announce message with series of PDUs 1 . . . N (e.g., the announce acknowledgment can be relatively small, so N may equal 1) corresponding to an acknowledgment that indicates the target UE's acceptance of the announced communication session over the RACH, 539, and the RAN 120 forwards the announce acknowledgment to the application server 170, 542. Also, after the announce acknowledgment (accept) message completes its transmission to the RAN 120 in 539, the RAN 120 transmits a reconfiguration message on the FACH to the target UE to facilitate a transition of the target UE to CELL_DCH state, 545. As will be appreciated, the reconfiguration message of 521 corresponds to a Radio Bearer (RB) Reconfiguration message, a Transport Channel (TCH) Reconfiguration message or a Physical Channel (PCH) Reconfiguration message, based on whether the Radio Bearer, Transport Channel or Physical Channel is the higher layer of the originating UE to be reconfigured.

Referring to FIG. 5, the originating UE receives the reconfiguration message, performs an L1 synchronization procedure, 548, completes transition to CELL_DCH state, 551, and then transmits a reconfiguration complete message on the DCH or E-DCH to the RAN 120, 554. While not shown explicitly in FIG. 5, the RAN 120 may be prompted to transition the target UE to CELL_DCH state at 521 based on downlink traffic (e.g., a dummy packet exceeding an Event 4a threshold) from the application server 170, in an example.

Turning back to the application server 170, after receiving the call acceptance acknowledgment from the target UE (or from a first responding target UE in the case of a group call), the application server 170 determines that the call can proceed and transmits a floor grant message to the RAN 120, 557, which transmits the floor grant message to the originating UE on the DCH or HS-DSCH, 560. The originating UE then begins to transmit media for the communication session to the RAN 120 over the DCH or E-DCH, 563, the RAN 120 forwards the media to the application server 170, 566, the application server 170 forwards the media back to a portion of the RAN 120 serving the target UE, 569, and the RAN 120 transmits the media to the target UE over the DCH or HS-DSCH, 572.

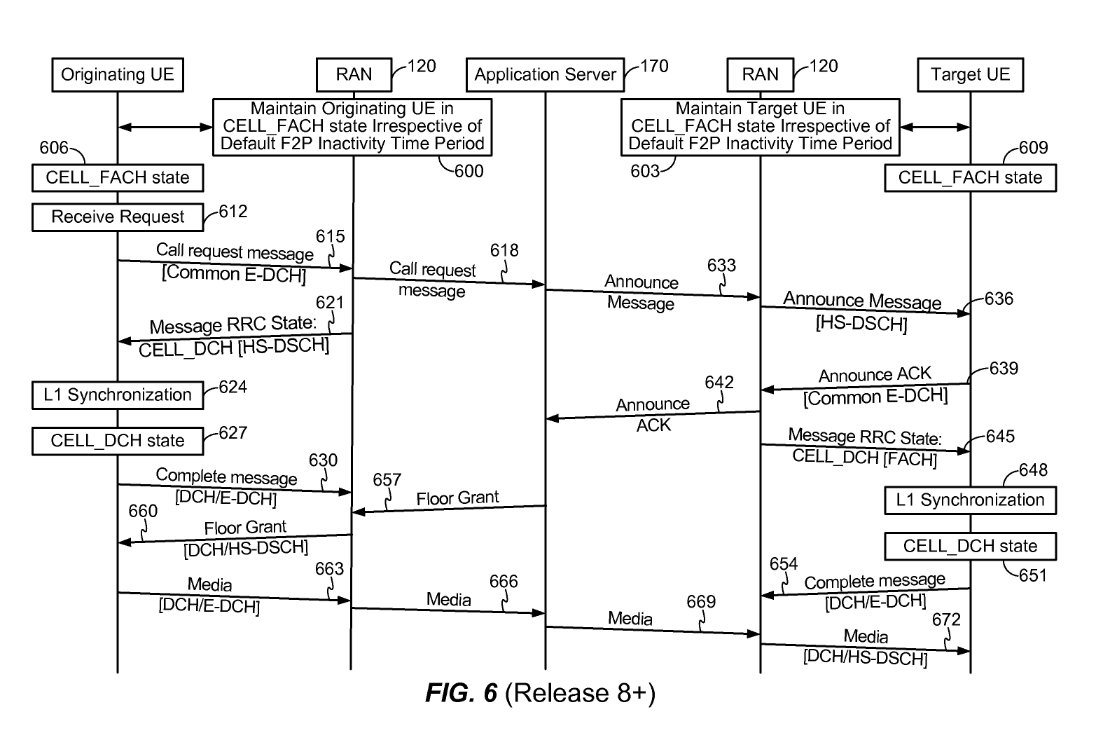

FIG. 6 illustrates another process of establishing a communication session between the originating UE and the target UE in accordance with another embodiment of the invention. FIG. 6 is similar in some respects to FIG. 5, except FIG. 6 is directed more specifically to a 3GPP Rel. 8+ implementation. In particular, Rel. 8 introduces the enhanced RACH (E-RACH) and the enhanced FACH (E-FACH) on HS-DSCH. Unlike the RACH, the E-RACH is implemented using a common E-DCH which is power controlled with hybrid Automatic Repeat Request (ARQ). By using the common E-DCH instead of the ARQ, larger packets (e.g., call request messages, etc.) do not need to be segmented into separate PDUs as described above with respect to FIG. 5 on the RACH at 515 and 536. Also, the E-FACH is implemented over the HS-DSCH which likewise permits transmissions of larger packets or PDUs.

Accordingly, except as noted below in this paragraph, 600 through 672 of FIG. 6 correspond to 500 through 572 of FIG. 5, respectively. In 615, the call request message is transmitted over the common E-DCH instead of the RACH as in 515 of FIG. 5. In 621, the Reconfiguration message is transmitted over the E-FACH on the HS-DSCH instead of the FACH as in 521 of FIG. 5. In 636, the announce message is transmitted over the E-FACH on the HS-DSCH instead of the FACH as in 536 of FIG. 5. In 639, the announce acknowledgment is transmitted over the common E-DCH instead of the RACH as in 539 of FIG. 5. As will be appreciated, even if the announce acknowledgment of 639, for example, is partitioned into several PDUs, the multiple PDUs can be transmitted in a single OTA transmission in 639 instead of separate OTA transmissions for each PDU as in 539 of FIG. 5. Similar OTA transmission efficiencies are also achieved for 615, 621 and 636 as compared with 515, 521 and 536, respectively, of FIG. 5.

FIGS. 7A through 7C each illustrate example implementations of 500, 503, 600 and/or 603 of FIGS. 5 and 6.

Referring to FIG. 7A, the RAN 120 identifies a given UE (e.g., the target UE or the originating UE from FIGS. 5 and/or 6) as a high-priority UE, 700A. For example, the RAN 120 can evaluate a subset of Quality of Service (QoS) attributes to identify high-priority or premium users. In an example, the traffic class associated with a QoS flow may be used to indicate high-priority status, such as an Interactive traffic class with a signaling indication. In another example, an address resolution protocol (ARP) parameter can be used to indicate high-priority state, such as a unique combination of PriorityLevel, PreemptionCapability, PreemptionVulnerability, and/or QueuingAllowed being to distinguish high-priority or premium subscribers from regular or lower-priority subscribers. For example, the SGSN 160 can learn the information indicative of high-priority (e.g., QoS attributes, traffic class, ARP parameter, etc.) during PDP context activation and then, when setting up the radio bearer (RAB), the SGSN can pass this information to the RAN 120 for performing the above-noted evaluation.

After identifying the given UE as a high-priority UE, the RAN 120 increases the F2P inactivity time period, 705A. For example, the F2P inactivity time period can be set to a very long period so as to significantly reduce a probability that the given UE will ever be transitioned from CELL_FACH state into a PCH state, such that the given UE can be dormant (or traffic inactive) for a relatively long period of time and still remain in CELL_FACH state.

Referring to FIG. 7A, the given UE transitions into CELL_FACH state in 710A. In an example, the transition of 710A can occur before, during or after the F2P inactivity time period extension operations of 700A and 705A. Once the given UE is transitioned into CELL_FACH state, the RAN 120 refrains from transitioning the given UE from CELL_FACH state back to CELL_PCH or URA_PCH state due to the extended F2P inactivity time period, 715A.

Referring to FIG. 7B, the RAN 120 need not determine whether the given UE is a high-priority UE and thereby does not extend the F2P inactivity time period for the given UE, 700B. Instead, the given UE transitions into CELL_FACH state in 705B, and after the given UE is transitioned into CELL_FACH state, the given UE begins to periodically transmit a packet (e.g., a Route Update (RUP) message, a proprietary or dummy packet, etc.) to the RAN 120 in order to deter a transition of the given UE from CELL_FACH state back to CELL_PCH or URA_PCH state, 715B. In an example, an interval between the periodic packet transmissions may be less than or equal to the F2P inactivity time period. Thus, in FIG. 7B, the given UE supplies some type of traffic activity so that the F2P inactivity timer continually resets and does not result in a transition of the given UE to a dormant condition. Further, it will be appreciated that the periodic transmission operation of 715B may only occur at the given UE when the given UE is not otherwise transmitting or receiving data that would itself be sufficient to maintain the given UE in CELL_FACH state. Accordingly, in FIG. 7B, the RAN 120 refrains from transitioning the given UE from CELL_FACH state back to CELL_PCH or URA_PCH state at least partially due to the RACH traffic (e.g., which includes RACH-based or E-RACH based traffic) from the given UE, 720B.

FIG. 7C implements a hybrid process that combines aspects from FIGS. 7A and 7B. Referring to FIG. 7C, the RAN 120 identifies the given UE as a high-priority UE, 700C, as in 700A of FIG. 7A. The RAN 120 then increments or extends the F2P inactivity time period in 705C, as in 705A of FIG. 7A. Unlike FIG. 7A, the RAN 120 notifies the given UE of the extended F2P inactivity time period in 710C. The given UE transitions into CELL_FACH state in 715C, and after the given UE is transitioned into CELL_FACH state, the given UE begins to periodically transmit a packet (e.g., a Route Update (RUP) message, a proprietary or dummy packet, etc.) to the RAN 120 in order to deter a transition of the given UE from CELL_FACH state back to CELL_PCH or URA_PCH state, 720C, similar to 715B of FIG. 7B. In an example, an interval between the periodic packet transmissions may be less than or equal to the extended F2P inactivity time period. Thus, in FIG. 7C, the RAN 120 is permitted to extend the F2P inactivity time period in a more moderate manner as compared to FIG. 7A, and then rely upon the given UE to further maintain the given UE in CELL_FACH state, if necessary, based on the periodic packet transmissions from 720C. Further, it will be appreciated that the periodic transmission operation of 720C may only occur at the given UE when the given UE is not otherwise transmitting or receiving data that would itself be sufficient to maintain the given UE in CELL_FACH state. Accordingly, in FIG. 7C, the RAN 120 refrains from transitioning the given UE from CELL_FACH state back to CELL_PCH or URA_PCH state in part due to the extended F2P inactivity time period and in part due to the RACH traffic (e.g., which includes RACH-based or E-RACH based traffic) from the given UE, 725C.

Further, while above-described examples are generally directed to maintaining high-priority UEs in CELL_FACH state, it will be appreciated that the above-described embodiments can be carried over to other wireless communication protocols. Thus, CELL_FACH state may correspond to any shared channel state when the above-described embodiments are implemented for other wireless communications protocols, so long as the shared channel state is characterized by (i) the UE not having dedicated channel resources, (ii) the UE required to monitor the downlink shared channel, (iii) the UE permitted to transmit on a reverse-link shared channel and the (iv) RAN 120 being configured to track a location of the UE at a sector-level of granularity such that paging is not necessary.

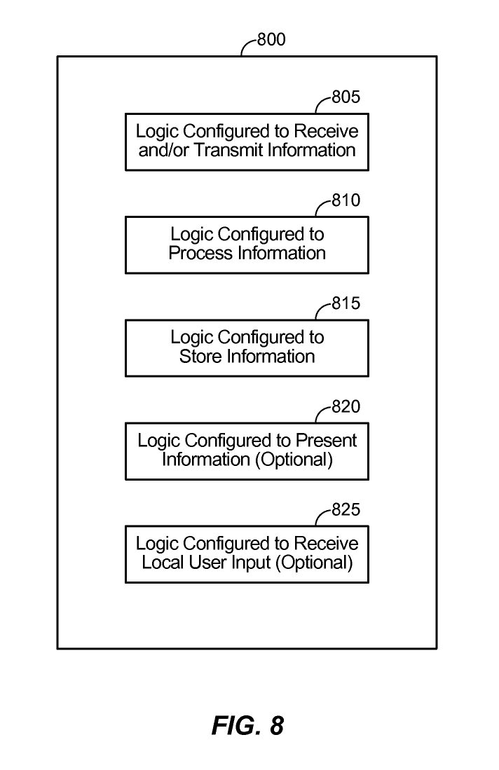

FIG. 8 illustrates a communication device 800 that includes logic configured to perform functionality. The communication device 800 can correspond to any of the above-noted communication devices, including but not limited to UEs 102, 108, 110, 112 or 200, Node Bs or base stations 124, the RNC or base station controller 122, a packet data network end-point (e.g., SGSN 160, GGSN 165, etc.), any of the servers 170 through 186, etc. Thus, communication device 800 can correspond to any electronic device that is configured to communicate with (or facilitate communication with) one or more other entities over a network.

Referring to FIG. 8, the communication device 800 includes logic configured to receive and/or transmit information 805. In an example, if the communication device 800 corresponds to a wireless communications device (e.g., UE 200, Node B 124, etc.), the logic configured to receive and/or transmit information 805 can include a wireless communications interface (e.g., Bluetooth, WiFi, 2G, 3G, etc.) such as a wireless transceiver and associated hardware (e.g., an RF antenna, a MODEM, a modulator and/or demodulator, etc.). In another example, the logic configured to receive and/or transmit information 805 can correspond to a wired communications interface (e.g., a serial connection, a USB or Firewire connection, an Ethernet connection through which the Internet 175 can be accessed, etc.). Thus, if the communication device 800 corresponds to some type of network-based server (e.g., SGSN 160, GGSN 165, application server 170, etc.), the logic configured to receive and/or transmit information 805 can correspond to an Ethernet card, in an example, that connects the network-based server to other communication entities via an Ethernet protocol. In a further example, the logic configured to receive and/or transmit information 805 can include sensory or measurement hardware by which the communication device 800 can monitor its local environment (e.g., an accelerometer, a temperature sensor, a light sensor, an antenna for monitoring local RF signals, etc.). The logic configured to receive and/or transmit information 805 can also include software that, when executed, permits the associated hardware of the logic configured to receive and/or transmit information 805 to perform its reception and/or transmission function(s). However, the logic configured to receive and/or transmit information 805 does not correspond to software alone, and the logic configured to receive and/or transmit information 805 relies at least in part upon hardware to achieve its functionality.

Referring to FIG. 8, the communication device 800 further includes logic configured to process information 810. In an example, the logic configured to process information 810 can include at least a processor. Example implementations of the type of processing that can be performed by the logic configured to process information 810 includes but is not limited to performing determinations, establishing connections, making selections between different information options, performing evaluations related to data, interacting with sensors coupled to the communication device 800 to perform measurement operations, converting information from one format to another (e.g., between different protocols such as .wmv to .avi, etc.), and so on. For example, the processor included in the logic configured to process information 810 can correspond to a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 810 can also include software that, when executed, permits the associated hardware of the logic configured to process information 810 to perform its processing function(s). However, the logic configured to process information 810 does not correspond to software alone, and the logic configured to process information 810 relies at least in part upon hardware to achieve its functionality.

Referring to FIG. 8, the communication device 800 further includes logic configured to store information 815. In an example, the logic configured to store information 815 can include at least a non-transitory memory and associated hardware (e.g., a memory controller, etc.). For example, the non-transitory memory included in the logic configured to store information 815 can correspond to RAM memory, flash memory, ROM memory, EPROM memory, EEPROM memory, registers, hard disk, a removable disk, a CD-ROM, or any other form of storage medium known in the art. The logic configured to store information 815 can also include software that, when executed, permits the associated hardware of the logic configured to store information 815 to perform its storage function(s). However, the logic configured to store information 815 does not correspond to software alone, and the logic configured to store information 815 relies at least in part upon hardware to achieve its functionality.

Referring to FIG. 8, the communication device 800 further optionally includes logic configured to present information 820. In an example, the logic configured to present information 820 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 800. For example, if the communication device 800 corresponds to UE 200 as shown in FIG. 3, the logic configured to present information 820 can include the display 224. In a further example, the logic configured to present information 820 can be omitted for certain communication devices, such as network communication devices that do not have a local user (e.g., network switches or routers, remote servers, etc.). The logic configured to present information 820 can also include software that, when executed, permits the associated hardware of the logic configured to present information 820 to perform its presentation function(s). However, the logic configured to present information 820 does not correspond to software alone, and the logic configured to present information 820 relies at least in part upon hardware to achieve its functionality.

Referring to FIG. 8, the communication device 800 further optionally includes logic configured to receive local user input 825. In an example, the logic configured to receive local user input 825 can include at least a user input device and associated hardware. For example, the user input device can include buttons, a touch-screen display, a keyboard, a camera, an audio input device (e.g., a microphone or a port that can carry audio information such as a microphone jack, etc.), and/or any other device by which information can be received from a user or operator of the communication device 800. For example, if the communication device 800 corresponds to UE 200 as shown in FIG. 3, the logic configured to receive local user input 825 can include the display 224 (if implemented a touch-screen), keypad 226, etc. In a further example, the logic configured to receive local user input 825 can be omitted for certain communication devices, such as network communication devices that do not have a local user (e.g., network switches or routers, remote servers, etc.). The logic configured to receive local user input 825 can also include software that, when executed, permits the associated hardware of the logic configured to receive local user input 825 to perform its input reception function(s). However, the logic configured to receive local user input 825 does not correspond to software alone, and the logic configured to receive local user input 825 relies at least in part upon hardware to achieve its functionality.

Referring to FIG. 8, while the configured logics of 805 through 825 are shown as separate or distinct blocks in FIG. 8, it will be appreciated that the hardware and/or software by which the respective configured logic performs its functionality can overlap in part. For example, any software used to facilitate the functionality of the configured logics of 805 through 825 can be stored in the non-transitory memory associated with the logic configured to store information 815, such that the configured logics of 805 through 825 each performs their functionality (i.e., in this case, software execution) based in part upon the operation of software stored by the logic configured to store information 805. Likewise, hardware that is directly associated with one of the configured logics can be borrowed or used by other configured logics from time to time. For example, the processor of the logic configured to process information 810 can format data into an appropriate format before being transmitted by the logic configured to receive and/or transmit information 805, such that the logic configured to receive and/or transmit information 805 performs its functionality (i.e., in this case, transmission of data) based in part upon the operation of hardware (i.e., the processor) associated with the logic configured to process information 810. Further, the configured logics or “logic configured to” of 805 through 825 are not limited to specific logic gates or elements, but generally refer to the ability to perform the functionality described herein (either via hardware or a combination of hardware and software). Thus, the configured logics or “logic configured to” of 805 through 825 are not necessarily implemented as logic gates or logic elements despite sharing the word “logic”. Other interactions or cooperation between the configured logics 805 through 825 will become clear to one of ordinary skill in the art from a review of the embodiments described above.

While references in the above-described embodiments of the invention have generally used the terms ‘call’ and ‘session’ interchangeably, it will be appreciated that any call and/or session is intended to be interpreted as inclusive of actual calls between different parties, or alternatively to data transport sessions that technically may not be considered as ‘calls’. Also, while above-embodiments have generally described with respect to PTT sessions, other embodiments can be directed to any type of communication session, such as a push-to-transfer (PTX) session, an emergency VoIP call, etc.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a user equipment (UE) served by an access network in a wireless communications system, comprising:
maintaining the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE monitoring a downlink shared channel from the access network, (iii), the UE permitted to transmit upon a reverse-link shared channel to the access network and (iv) the access network expected to be tracking a location of the UE at a sector-level granularity;
receiving a request to set-up a communication session while the UE is in the shared channel state; and
transmitting, in response to the received request, a message associated with set-up of the communication session on the reverse-link shared channel.

2. The method of claim 1, wherein the UE corresponds to an originating UE of the communication session.

3. The method of claim 2, wherein the received request is received from a user of the UE and the transmitted message corresponds to a call request message that is configured to request set-up of the communication session by an application server.

4. The method of claim 1, wherein the UE corresponds to a target UE of the communication session.

5. The method of claim 4, wherein the received request corresponds to an announce message that announces the communication session and the transmitted message corresponds to an acknowledgment of the announce message that indicates acceptance of the announced communication session by the target UE.

6. The method of claim 1, wherein the shared channel state corresponds to a CELL_FACH, the dormant state corresponds to CELL_PCH or URA_PCH state and the dedicated channel state corresponds to CELL_DCH state.

7. The method of claim 1, wherein the reverse-link shared channel corresponds to a reverse access channel (RACH).

8. The method of claim 7, wherein the RACH corresponds to an enhanced RACH (E-RACH) that is implemented over a common enhanced dedicated channel (E-DCH).

9. The method of claim 1, wherein the downlink shared channel corresponds to a forward access channel (FACH) or a High-Speed Downlink Shared Channel (HS-DSCH).

10. The method of claim 1, wherein the maintaining step is based upon operation of the access network such that the UE is not transitioned to the dormant state by the access network when traffic inactivity between the UE and the access network extends beyond the threshold inactivity period.

11. The method of claim 10, wherein the operation of the access network corresponds to the access network extending the threshold inactivity period.

12. The method of claim 1, wherein the maintaining step includes:
periodically transmitting a packet to the access network that is configured to deter a transition of the UE from the shared channel state to the dormant state.

13. The method of claim 12, wherein the packet corresponds to a proprietary keep alive packet or a Route Update (RUP) message.

14. The method of claim 12, wherein an interval between period transmissions of the packet is less than or equal to (i) the threshold inactivity period or (ii) an extended version of the threshold inactivity period.

15. The method of claim 1, further comprising:
transitioning the UE, after the message is transmitted, to the dedicated channel state for supporting the communication session.

16. A method of operating an access network configured to serve a user equipment (UE) network in a wireless communications system, comprising:
maintaining the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE expected to be monitoring a downlink shared channel from the access network, (iii), the UE permitted to transmit upon a reverse-link shared channel to the access network and (iv) the access network tracking a location of the UE at a sector-level granularity; and
receiving a request to set-up a communication session from the UE over the reverse-link shared channel while the UE is in the shared channel state.

17. The method of claim 16, wherein the UE corresponds to an originating UE of the communication session.

18. The method of claim 17, wherein the received request corresponds to a call request message that is configured to request set-up of the communication session by an application server.

19. The method of claim 16, wherein the UE corresponds to a target UE of the communication session.

20. The method of claim 19, further comprising:
transmitting an announce message to the target UE that is configured to announce the communication session,
wherein the received request corresponds to an acknowledgment of the announce message that indicates acceptance of the announced communication session by the target UE.

21. The method of claim 16, wherein the shared channel state corresponds to a CELL_FACH, the dormant state corresponds to CELL_PCH or URA_PCH state and the dedicated channel state corresponds to CELL_DCH state.

22. The method of claim 16, wherein the reverse-link shared channel corresponds to a reverse access channel (RACH).

23. The method of claim 22, wherein the RACH corresponds to an enhanced RACH (E-RACH) that is implemented over a common enhanced dedicated channel (E-DCH).

24. The method of claim 16, wherein the downlink shared channel corresponds to a forward access channel (FACH) or a High-Speed Downlink Shared Channel (HS-DSCH).

25. The method of claim 16, wherein the maintaining step includes:
extending the threshold inactivity period.

26. The method of claim 16, wherein the maintaining step includes:
periodically receiving a packet from the UE that is configured to deter a transition of the UE from the shared channel state to the dormant state.

27. The method of claim 26, wherein the packet corresponds to a proprietary keep alive packet or a Route Update (RUP) message.

28. The method of claim 27, wherein an interval between period transmissions of the packet is less than or equal to (i) the threshold inactivity period or (ii) an extended version of the threshold inactivity period.

29. The method of claim 16, further comprising:
transitioning the UE, after the request is received, to the dedicated channel state for supporting the communication session.

30. A user equipment (UE) served by an access network in a wireless communications system, comprising:
means for maintaining the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE monitoring a downlink shared channel from the access network, (iii), the UE permitted to transmit upon a reverse-link shared channel to the access network and (iv) the access network expected to be tracking a location of the UE at a sector-level granularity;
means for receiving a request to set-up a communication session while the UE is in the shared channel state; and
means for transmitting, in response to the received request, a message associated with set-up of the communication session on the reverse-link shared channel.

31. An access network configured to serve a user equipment (UE) network in a wireless communications system, comprising:
means for maintaining the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE expected to be monitoring a downlink shared channel from the access network, (iii), the UE permitted to transmit upon a reverse-link shared channel to the access network and (iv) the access network tracking a location of the UE at a sector-level granularity; and
means for receiving a request to set-up a communication session from the UE over the reverse-link shared channel while the UE is in the shared channel state.

32. A user equipment (UE) served by an access network in a wireless communications system, comprising:
logic configured to maintain the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE monitoring a downlink shared channel from the access network, (iii), the UE permitted to transmit upon a reverse-link shared channel to the access network and (iv) the access network expected to be tracking a location of the UE at a sector-level granularity;
logic configured to receive a request to set-up a communication session while the UE is in the shared channel state; and
logic configured to transmit, in response to the received request, a message associated with set-up of the communication session on the reverse-link shared channel.

33. An access network configured to serve a user equipment (UE) network in a wireless communications system, comprising:
logic configured to maintain the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE expected to be monitoring a downlink shared channel from the access network, (iii), the UE permitted to transmit upon a reverse-link shared channel to the access network and (iv) the access network tracking a location of the UE at a sector-level granularity; and
logic configured to receive a request to set-up a communication session from the UE over the reverse-link shared channel while the UE is in the shared channel state.

34. A non-transitory computer-readable medium containing instructions stored thereon, which, when executed by a user equipment (UE) served by an access network in a wireless communications system, cause the UE to perform operations, the instructions comprising:
program code to maintain the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE monitoring a downlink shared channel from the access network, (iii), the UE permitted to transmit upon a reverse-link shared channel to the access network and (iv) the access network expected to be tracking a location of the UE at a sector-level granularity;
program code to receive a request to set-up a communication session while the UE is in the shared channel state; and
program code to transmit, in response to the received request, a message associated with set-up of the communication session on the reverse-link shared channel.

35. A non-transitory computer-readable medium containing instructions stored thereon, which, when executed by an access network configured to serve a user equipment (UE) network in a wireless communications system, cause the access network to perform operations, the instructions comprising:
program code to maintain the UE in a shared channel state during a period of UE-traffic inactivity that exceeds a threshold inactivity period associated with transitions of the UE from the shared channel state to a dormant state, the shared channel state being characterized by (i) the UE not being in a dedicated channel state with dedicated channel resources allocated to the UE, (ii) the UE expected to be monitoring a downlink shared channel from the access network, (iii), the UE permitted to transmit upon a reverse-link shared channel to the access network and (iv) the access network tracking a location of the UE at a sector-level granularity; and
program code to receive a request to set-up a communication session from the UE over the reverse-link shared channel while the UE is in the shared channel state.
